(19) United States
(12) Patent Application Publication
(10) Pub. No.: US 2022/0249888 A1
(43) Pub. Date: Aug. 11, 2022

(54) Multiple Self-Retracting Lanyard, Single Brake Fall Protection Systems and Methods

(71) Applicant: The Boeing Company, Chicago, IL (US)

(72) Inventors: Gerald O. Pollard, Snohomish, WA (US); Kory K. DeHart, Mount Vernon, WA (US)

(73) Assignee: The Boeing Company, Chicago, IL (US)

(21) Appl. No.: 17/483,957

(22) Filed: Sep. 24, 2021

Related U.S. Application Data
(60) Provisional application No. 63/148,213, filed on Feb. 11, 2021.

(51) Int. Cl. A62B 35/00

(52) U.S. Cl. CPC A62B 35/0093; A62B 35/0075

(57) ABSTRACT

Fall protection systems and methods for a load in an elevated position include at least two self-retracting lanyards configured to be removably coupled to the load. The at least two self-retracting lanyards are associated with a single braking system that arrests movement of the at least two self-retracting lanyards when the single braking system mechanically senses that a speed of any one of the at least two self-retracting lanyards has increased to a threshold brake speed that indicates the load is falling from the elevated position.

### TECHNICAL FIELD

This disclosure relates generally to fall protection systems and methods that actively arrest a fall from an elevated position and, more particularly, to fall protection systems and methods for eliminating swing risk when a load falls from an elevated position.

### BACKGROUND

In various workplace environments, workers, platforms, scaffolding, equipment, products, and other loads are positioned at elevated heights either by placing a load on an elevated work surface and/or by suspending a load from one or more cables for maintaining the load in an elevated position. Examples of such workplace environments include, but are not limited to, large scale assembly facilities, aviation construction and maintenance platforms, building construction and maintenance platforms, ladders, and the like. Fall protection systems are used in such workplace environments to protect the loads and the surrounding structures and personnel when the loads accidentally fall from their elevated positions.

Existing fall protection systems are often implemented as self-retracting lanyards (also called “SRL”, self-retracting lifelines, fall arrestors or load arrestors) that are configured to limit a vertical distance a load can fall from an elevated position. Self-retracting lanyards include a lanyard or lifeline (referred to herein as a lifeline) wrapped around a spring-biased spool or reel and a brake inside a housing unit. A distal end of the lifeline has a coupling device, such as a carabiner, for coupling the self-retracting lanyard to a load or to an independent anchor point of a structure above the load's elevated position. The housing unit has a connector for attaching the housing unit to the independent anchor point or the load. The spring-biased spool is biased to automatically rotate the spool in a direction that retracts the lifeline into the housing unit and around the spool when the load is not applying an outward force to the lifeline.

When the load applies a pulling force to the lifeline of the self-retracting lanyard, the lifeline extends out of the housing unit, and the spring-biased spool provides a slight tension on the lifeline in an opposite direction, so the minimum amount of lifeline required is exposed at any given time. If the load falls from an elevated position, a greater pulling force will be applied, and the lifeline will rapidly extend further out of the housing unit causing the spring-biased spool to rotate faster in the direction opposite the bias. The brake in the housing unit is activated when the rotational speed of the spring-biased spool reaches a threshold brake speed in the direction opposite the spring bias, thereby arresting the spool's rotation, arresting further extension of the lifeline, and arresting the load from falling further.

Such systems often require the load to move through a minimum vertical deceleration distance after a fall before the arresting action of the brake occurs. If the independent anchor point for the self-retracting lanyard is not directly above the load's center of gravity when the load falls from the elevated position, i.e., the lifeline is at an angle greater than 0° relative to the fall direction of the load, the load will move in a horizontal direction in addition to the vertical deceleration distance like a pendulum, otherwise known as swing, which may cause damage or injury to the load or to the surrounding structures or personnel.

One solution to minimize swing has been to attach a self-retracting lanyard to a trolley which is attached to and moves along a solid structure, such as an I-beam, above the load. However, this solution requires additional structure, which may not be available, appropriate, or cost effective, and diligence from a user of the system to move the trolley so it remains directly above the load's center of gravity. This solution also limits travel to one direction and only as far as the trolley can extend.

Another solution is to use multiple self-retracting lanyards anchored so that the load's center of gravity is between the self-retracting lanyards. However, this type of system is not effective because it does not guarantee that more than one of the self-retracting lanyards will engage during a fall. When the brake in one of the self-retracting lanyards engages, the momentum from the fall is stopped and the brakes in the remaining self-retracting lanyards will not sense the fall. Thus, the remaining self-retracting lanyards will not engage. With one of the multiple self-retracting lanyards arresting a fall while other lifelines remain free to extend, the load will move in a horizontal direction; thus, the swing risk is still present. Further, this type of system should maintain commonality between the multiple self-retracting lanyards (i.e., the angle between the lifeline and the fall direction needs to be equal for all the self-retracting lanyards and all the self-retracting lanyards should be of the same make and quality). Therefore, anchoring options and movement of the load are also limited.

### BRIEF DESCRIPTION

Systems and methods are disclosed herein that provide an improved approach to fall protection with multiple self-retracting lanyards that share a single braking system and form a fall protection system. The multiple self-retracting lanyards have respective lifelines wound on respective spools (or reels) which operate independently when a load, such as a worker, platform, scaffolding, equipment, or product is maintained at an elevated position on an elevated work surface and/or by suspending the load from one or more cables or other devices. That is, each of the lifelines in the multiple self-retracting lanyards can be extended at different speeds, lengths, and times, and be automatically retracted at different times depending on the forces the load applies to each of the lifelines during use.

When a load falls from the elevated position, however, the single braking system senses or reacts when a rotational speed of any one of the respective spools in the multiple self-retracting lanyards increases to a threshold brake speed, upon which the single braking system is engaged to simultaneously arrest rotation of all the spools and extension of all the lifelines of the multiple self-retracting lanyards. All the lifelines are taut because of the weight of the load when it is hanging by the arrested lifelines and do not permit the load to move in a horizontal direction. Thus, the risk of a swing hazard is eliminated regardless of whether the self-retracting lanyards are evenly spaced apart (i.e., the lifeline to fall direction angle need not be equal for all self-retracting lanyards) or placed directly over the load's center of gravity.

In one aspect, a fall protection system for a load in an elevated position is provided. The fall protection system includes at least two self-retracting lanyards configured to be removably coupled to the load and to an independent anchor point preferably above the load. The at least two self-retracting lanyards are associated with a single braking system that arrests movement of the at least two self-retracting lanyards when a speed of any one of the at least two self-retracting lanyards has increased to a threshold brake speed. The at least two self-retracting lanyards include respective lifelines wound on respective spools, and the respective spools are independently rotatable around a central axle of the fall protection system. The single braking system is operable to arrest movement of the respective spools when the single braking system mechanically senses that a rotational speed of any one of the respective spools has increased to the threshold brake speed.

The single braking system includes at least two brake assemblies respectively associated with the respective spools of the at least two self-retracting lanyards and rotatable around the central axle of the fall protection system. The brake assemblies rotate at a speed equal to the rotational speed of the fastest rotating one of the respective spools. In the single braking system, at least one pawl is movable by centrifugal force acting against a spring force and positioned to engage an end brake gear to arrest movement of the at least two brake assemblies and the respective spools when at least one of the respective spools has reached the threshold brake speed. In certain aspects of the fall protection system, the single braking system employs at least two pawls that are radially positioned around the central axle at unequal radial angles or unequal radial positions and are engageable with the end brake gear. In other aspects, the single braking system employs one or more pawls that engage a gear formed by an outer edge of a recessed space in a side of the respective spools and when more than one of these pawls is employed, the pawls are radially positioned around the central axle at unequal radial angles or unequal radial positions.

In another aspect, a braking system is disclosed for simultaneously arresting movement of at least two self-retracting lanyards. The braking system includes a first spool brake assembly that rotates around a central axle and is positioned to react with a first gear formed by an outer edge of a recessed space in a side of a first spool of a first self-retracting lanyard. A second spool brake assembly is positioned to rotate around the central axle and react with a second gear formed by an outer edge of a recessed space in a side of a second spool of a second self-retracting lanyard. The second spool brake assembly is connected to the first spool brake assembly through a torsion shaft that is also rotatable around the central axle. An end brake assembly is positioned to rotate around the central axle and is coupled to the first spool brake assembly such that the first spool brake assembly, the torsion shaft, the second spool brake assembly, and the end brake assembly rotate around the central axle at equal speeds. The braking system has at least one pawl that is movable by centrifugal force acting against a spring force to engage an end brake gear to arrest movement of the end brake assembly, the first spool brake assembly, the second spool brake assembly, the first spool, and the second spool when a first rotational speed of the first spool or a second rotational speed of the second spool reaches a threshold brake speed. In certain aspects of the braking system, two or more pawls are radially positioned around the central axle at unequal radial positions and/or unequal radial angles to engage the end brake gear.

In another aspect, a method for protecting a load when falling from an elevated position is disclosed. In the method, at least two self-retracting lanyards are removably coupled to the load and the method includes operating the self-retracting lanyards independently when the load is maintained in the elevated position. The method further includes mechanically sensing when a speed of any one of the at least two self-retracting lanyards has increased to a threshold brake speed; and when it is sensed that the speed of any one of the at least two self-retracting lanyards has increased to the threshold brake, engaging a single braking system associated with the at least two self-retracting lanyards to arrest movement of the at least two self-retracting lanyards.

The at least two self-retracting lanyards are configured with respective lifelines wound on respective spools that are configured to rotate independently of each other. In the method, engaging the single braking system includes engaging a gear to arrest movement of the respective spools when mechanically sensing that the rotational speed of any of the respective spools associated with the self-retracting lanyards has increased to the threshold brake speed. The method also includes deploying at least one pawl that is movable by centrifugal force acting against a spring force when the rotational speed of any of the respective spools has increased to the threshold brake speed. In certain aspects of the method, the at least one pawl engages an end brake gear of a brake assembly to arrest movement of the single braking system and the respective spools.

In another aspect, a method of making a fall protection system includes disposing at least two self-retracting lanyards in a housing of the fall protection system and associating the at least two self-retracting lanyards with a single braking system in the housing that arrests movement of the at least two self-retracting lanyards in the event of an increased speed of any one of the at least two self-retracting lanyards to the threshold brake speed.

The disclosed systems and methods eliminate the risk of a swing hazard by ensuring that movement of all lifelines in the self-retracting lanyards is simultaneously arrested by the single braking system, and the systems and methods provide continuous and unrestrained safe travel along a two-dimensional or three-dimensional work area or length. No additional support structure is required, such as a trolley system, and there is no need to maintain commonality of the multiple self-retracting lanyards. The disclosed systems and methods permit many possible anchoring configurations and provide a safe way for a load to “leap-frog”, i.e., the action of a load passing between one set of self-retracting lanyard anchor points to another set while maintaining active fall protection. This allows for safe extended work areas when limited by anchoring height restrictions, lifeline length, and other structural limitations.

The foregoing features, functions, and advantages of the disclosed systems and methods, as well as other objects, features, functions, and advantages of the disclosed systems and methods can be achieved independently in various examples of the disclosure or may be combined in yet other examples further details of which can be seen with reference to the following detailed description and drawings.

### BRIEF DESCRIPTION OF THE DRAWINGS

Various implementations of the disclosure will be hereinafter described with reference to drawings for the purpose of illustrating the above-described and other aspects. None of the drawings briefly described in this section are drawn to scale.

FIG. 1 is a perspective view of a fall protection system having multiple self-retracting lanyards and a single braking system in a common housing.

FIG. 2 is an illustration showing an exemplary use of the fall protection system shown in FIG. 1.

FIG. 3 is an exploded view of the fall protection system shown in FIG. 1.

FIG. 4A is an exploded view of a self-retracting lanyard for use with the fall protection system shown in FIG. 1.

FIG. 4B is a side view of a self-retracting lanyard positioned in the common housing of the fall protection system shown in FIG. 1.

FIG. 4C is a perspective view of two self-retracting lanyards of the type shown in FIG. 4A positioned next to each other.

FIG. 4D is an illustration of four self-retracting lanyards of the type shown in FIG. 4A positioned next to each other.

FIG. 5A is a perspective view of a single braking system for use with the fall protection system shown in FIG. 1.

FIG. 5B is an exploded view of the single braking system shown in FIG. 5A.

FIG. 5C is a side view of a spool brake assembly of the single braking system shown in FIG. 5A.

FIG. 5D is a side view of an end brake assembly of the single braking system shown in FIG. 5A.

FIG. 6A is a side view of the fall protection system shown in FIG. 1 with end plates of the common housing removed.

FIG. 6B is a side view of the end brake assembly reacting with an end brake gear of the single braking system.

FIG. 7 is a block diagram showing a method for protecting a load when falling from an elevated position.

Reference will hereinafter be made to the drawings in which similar elements in different drawings bear the same reference numerals. Where reference is made in any one or more of the accompanying drawings to steps and/or features, which have the same reference numerals, those steps and/or features have, for the purposes of this description, the same function(s) or operator(s), unless the contrary intention is apparent.

### DETAILED DESCRIPTION

Illustrative implementations of fall protection systems and methods are described in some detail below. A person skilled in the art will appreciate that in the development of an actual implementation of the disclosed systems and methods, numerous implementation-specific decisions could be made to achieve a developer's specific goals, such as compliance with system-related and business-related constraints, which will vary from one implementation to another. It will be appreciated that such a development effort might be complex and time-consuming but would nevertheless be a routine undertaking for those of ordinary skill in the art having the benefit of this disclosure. Moreover, the disclosed systems and methods can be used or readily adapted for use in any industry and in any work environment where falls are an inherent risk.

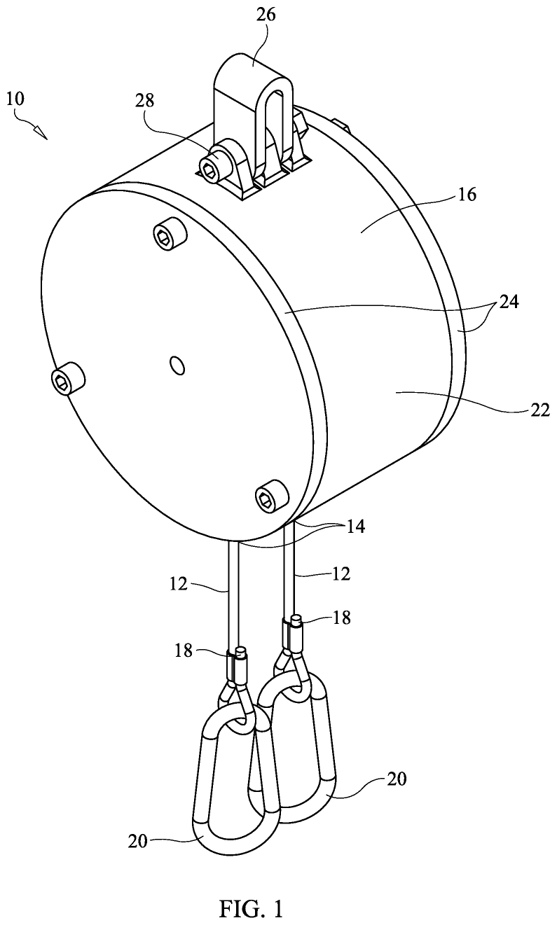

FIG. 1 illustrates a fall protection system 10 in an assembled form having two lifelines 12 that extend through one or more openings 14 in a bottom part of a housing 16. The lifelines 12 may be implemented as a flexible line of rope, wire rope, or a flat strap having a distal end 18 configured to be coupled to a coupling device 20 such as a carabiner, which can be removably coupled to a load. The distal end 18 of the lifelines 12 may be formed into a loop or be connected to an O-ring, D-ring or similar type of device that can securely hold the coupling device 20. The housing 16 includes a center body 22 having two opposing open sides and two end plates 24 to close the open sides. An anchor 26 is positioned on an exterior surface of a top part of the center body 22 (opposite the openings 14 for the lifelines 12 on a bottom part of the center body 22). The anchor 26 is connected to the center body 22 of the housing 16 with a static, non-movable connection or with a movable connection, such as with a hinge pin 28 that permits the anchor 26 to rotate as shown in FIG. 1. It will be apparent to a person of ordinary skill in the art using this disclosure as a reference that the number of lifelines 12 in the fall protection system 10, as well as the size and form of the housing, can be readily adapted for different applications.

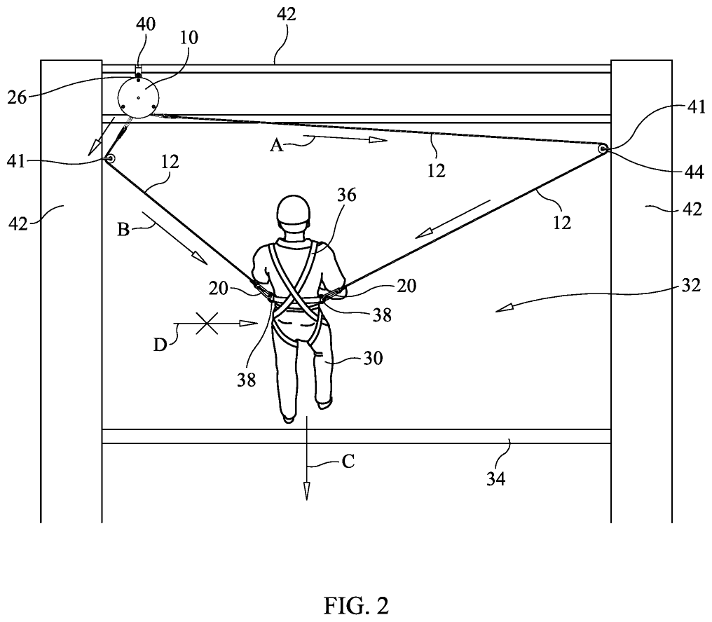

FIG. 2 illustrates one exemplary use of the fall protection system 10 for protecting a load 30 in an elevated position 32. In this example, the load 30 is a person or worker, but the fall protection system 10 can be used to protect any type of load 30 that is placed in an elevated position 32 at a height above the ground. For example, the load 30 may be a worker, platform, scaffolding, railing system, equipment, or product, such as the skin of an aircraft fuselage, that is maintained in an elevated position 32. The load 30 may be positioned on an elevated platform 34 in the elevated position 32 (such as the worker shown in FIG. 2) or instead of a worker the load 30 may be an elevated platform 34 on which a worker is standing or a piece of equipment suspended by cables or other types of suspension devices in the elevated position 32 (such as heavy equipment that needs to be lifted and moved into place for installation or maintenance).

The lifelines 12 of the fall protection system 10 are removably coupled to the load 30 through the coupling device 20. The load 30 may have a harness 36 with one or more harness connectors 38 positioned on the sides and/or top or front of the load 30 to facilitate coupling the harness 36 to the coupling device 20 on each of the lifelines 12. For example, in FIG. 2, a worker (the load 30) dons a harness 36 with two harness connectors 38 that are positioned on the worker's hips. In some applications, a third harness connector can be added on or near the worker's chest, and the number of lifelines 12 in the fall protection system 10 can be readily increased to accommodate additional harness connectors for a particular application. The harness 36 is any suitable harness and the harness connectors 38 are any suitable connectors that enable the fall protection system 10 to function as described herein. The harness 36 may be configured in any manner to accommodate any size and shape of the load 30.

The fall protection system 10 is removably coupled to a system anchor point 40 affixed to or made a part of a rigid support structure 42 through the anchor 26 with a mechanical coupling. The rigid support structure 42 and the mechanical coupling to the system anchor point 40, together with the fall protection system 10, are configured to support a weight of the load 30 and any equipment carried by the load 30, plus any dynamic acceleration force caused by a potential fall of the load 30 from the elevated position 32. The system anchor point 40 is mechanically coupled to the rigid support structure 42 above the load 30 but may also be mechanically coupled to any location above the elevated platform 34 or mechanically coupled to the elevated platform 34. The system anchor point 40 may also be positioned at any point along the length of the rigid support structure 42. One or more pulleys 44 affixed to or made a part of the rigid support structure 42 may be used to create pulley anchor points 41 to provide separation of the lifelines 12 and permit the center of gravity of the load 30 to be between the lifelines 12 and between the pulley anchor points 41. The pulleys 44 can be positioned in many numbers of configurations as needed for a particular application to provide for both two-dimensional and three-dimensional workspaces.

The fall protection system 10 is configured to extend each of the lifelines 12 independently in response to a pulling force (shown by arrows A and B) from the load 30 until a maximum length is reached. That is, if a pulling force is applied to one of the lifelines 12 (e.g., arrow A), then that lifeline will extend, and the other lifeline will retract. For example, if the load 30 is moved toward one of the pulley anchor points 41, the lifeline associated with that one of the pulley anchor points 41 will retract automatically while the lifeline associated with the other of the pulley anchor points 41 will extend or be maintained in its position depending on where it is located. Thus, as the load 30 moves around or is moved in the elevated position 32, the lifelines 12 selectively and independently extend and retract in response to that movement and the lifelines 12 are maintained in tension between the load 30 and the system anchor point 40 and the pulley anchor points 41 to reduce any interference with the load 30 and its movement.

If the load 30 falls from the elevated position 32, a greater dynamic accelerating force will be applied to one or more of the lifelines 12 causing one or more of the lifelines 12 to rapidly extend from the fall protection system 10. The fall protection system 10 is configured to mechanically sense when a speed of any one of the lifelines 12 increase to a threshold brake speed and, when it does, to simultaneously arrest movement of all the lifelines 12, thus stopping the load 30 from falling further and preventing any horizontal movement or swing of the load 30. The fall protection system 10 therefore eliminates the risk of a swing hazard by limiting the fall of a load 30 from an elevated position 32 to a deceleration distance set by the amount of time it takes for any one of the lifelines to reach the threshold brake speed and limiting the fall direction to a vertical direction (shown by arrow C). If extension of just one of the lifelines 12 is arrested, then the load 30 will swing in the horizontal direction (shown by arrow D) in addition to falling in the vertical direction, presenting the risk of the load 30 colliding with the rigid support structure 42 or personnel, equipment, or other structures below the elevated position 32. This risk is eliminated by the fall protection system 10 disclosed herein by arresting movement of all lifelines 12 simultaneously in the event of a fall. It is not necessary for the lifelines 12 to be positioned equally around the load 30 so that the angles between the fall and each of the lifelines 12 are equal. In addition, the load 30 can “leap-frog” by, for example, transferring the one of the lifelines 12 on the harness connector 38 on the right side to the harness connector 38 on the left side when a center connection is reached. This is done safely as the fall protection system 10 maintains active fall protection during the transfer. The fall protection system 10 therefore provides improved functionality and cost-effectiveness as compared to using a trolley or multiple lifelines 12 having separate brakes.

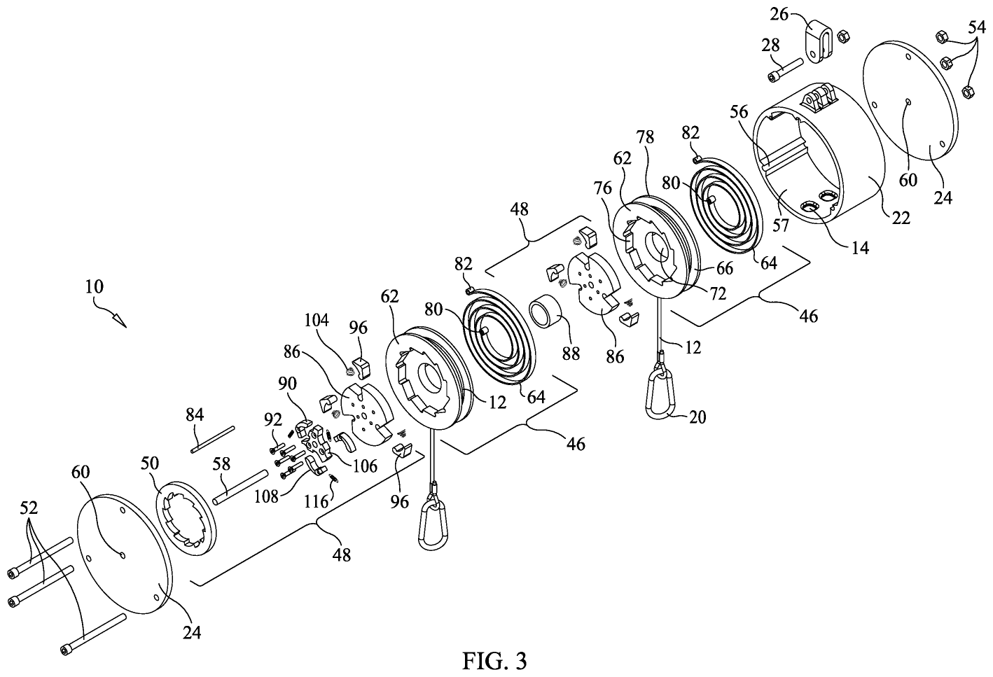

FIG. 3 shows an exploded view of the fall protection system 10 including two or more self-retracting lanyards 46 and a single braking system 48 contained by the housing 16 (shown in FIG. 1). The housing 16 includes the center body 22 and two end plates 24, which close the open sides of the center body 22. An end brake gear 50 of the single braking system 48 is welded or fastened to an interior surface of one of the two end plates 24 and provides a locking feature for the single braking system 48 supported by the one of the two end plates 24 of the housing 16. The two end plates 24 are secured to the center body 22 with a plurality of bolts 52 that extend through one of the two end plates 24, through the center body 22, and through the other of the two end plates 24 and are secured with nuts 54. The bolts 52 are positioned in recessed tracks 56 formed on an inner circumferential surface 57 of the center body 22, which permit the bolts 52 to rotate within the recessed tracks 56. A central axle 58 extends through the center body 22 and is welded, fastened, or otherwise secured to a central point 60 on each of the interior surfaces of the two end plates 24.

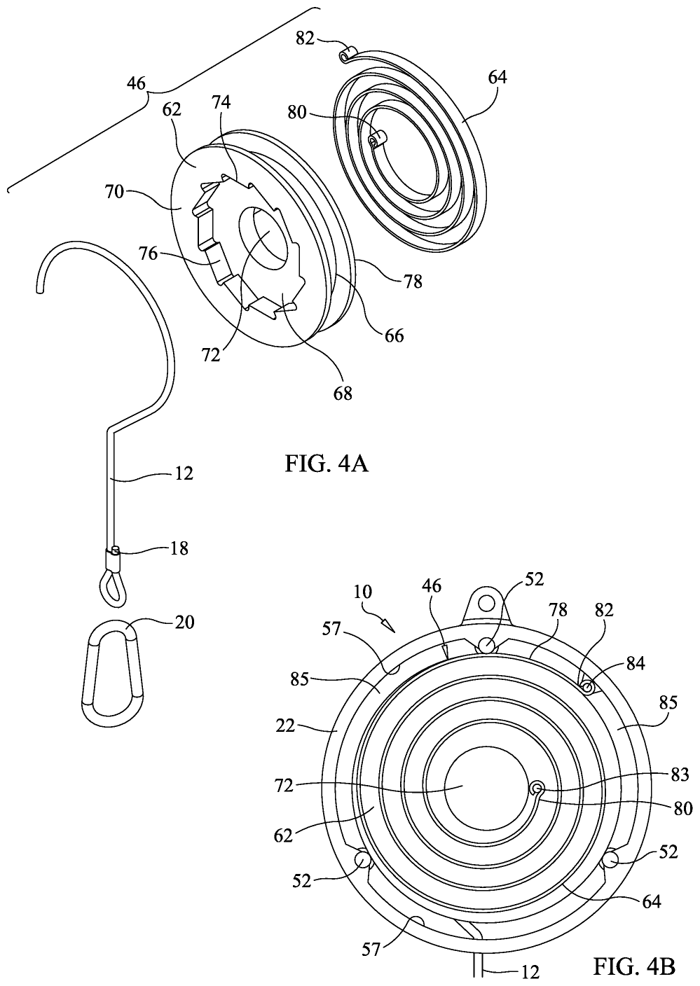

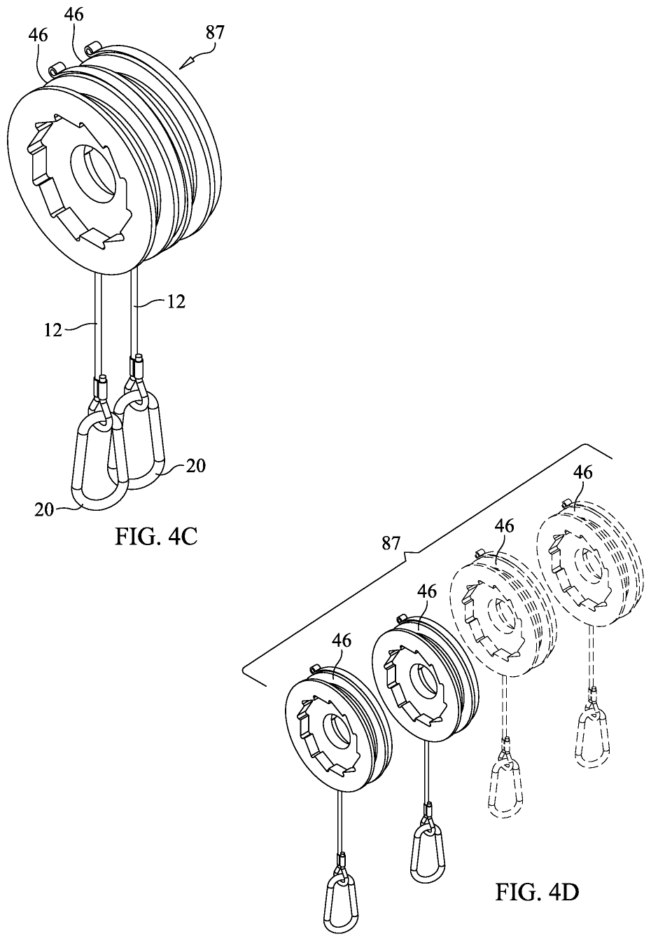

Referring to FIG. 4A, each of the self-retracting lanyards 46 includes a spool 62, a rotor spring 64, a lifeline 12 as described above wound around the spool 62 in a circumferential recessed track 66 surrounding the spool 62, and a coupling device 20 coupled to a distal end 18 of the lifeline 12. The spool 62 has a recessed space 68 having a circular shape recessed into a side surface 70 of the spool 62 and a central hole 72 that extends through the width of the spool 62. An outer edge 74 of the recessed space 68 forms a spool gear 76 that is operably engaged by or reacts with the single braking system 48, as will be described herein. The central hole 72 of the spool 62 is aligned with a center of the recessed space 68 and in the housing 16 with the central point 60 on each of the two end plates 24 (see FIG. 3). The spool 62 in each of the self-retracting lanyards 46 is configured to rotate independently around the central axle 58 of the fall protection system 10 and a torsion shaft 88 of the single braking system 48 as hereinafter described.

FIG. 4B illustrates a side view of one of the self-retracting lanyards 46 positioned in the center body 22 of the housing 16. At least a second one of the self-retracting lanyards 46 is positioned behind or in front of the one shown in FIG. 4B (see FIG. 3). The central axle 58 of the fall protection system 10 and the torsion shaft 88 of the single braking system 48 extend through the central hole 72 of the spool 62 in each of the self-retracting lanyards 46 and a circumferential edge 78 of the spool 62 in each of the self-retracting lanyards 46 is positioned against the bolts 52, which act as rollers so the spool 62 is freely rotatable around the central axle 58 and the torsion shaft 88. Alternatively, rollers can be provided around the central axle 58 or around the central hole 72 between the spool 62 and the central axle 58 to facilitate free rotation of the spool 62 around the central axle 58.

The rotor spring 64 is a coiled spring having an interior end 80 positioned near a center of the coil and an exterior end 82 at an outer layer of the coil. The interior end 80 is attached to the spool 62 on the side of the spool 62 opposite the side surface 70 having the recessed space 68 with a pin 83 or any other suitable means for retaining interior end 80 in the desired position. The interior end 80 of the rotor spring 64 is positioned adjacent to a circumference of the central hole 72 in the spool 62. The exterior end 82 of the rotor spring 64 is attached to the housing 16 with a rotor spring pin 84 that extends through a circumferential space 85 between the circumferential edge 78 of the spool 62 and an inner circumferential surface 57 of the center body 22 of the housing 16 and is welded, fastened, or otherwise secured to the two end plates 24. The rotor spring pin 84 also extends through the exterior end 82 of the rotor spring 64, which is formed into a loop, to provide an anchor point for the rotor spring 64 on the housing 16 and retain the exterior end 82 of the rotor spring 64 in position when the lifeline 12 is extended and retracted from the housing 16.

The rotor spring 64 is biased to a neutral position so that it creates tension in the lifeline 12 when a pulling force is applied to the lifeline 12 (i.e., when the lifeline 12 is extended out of the center body 22 of the housing 16, the rotor spring 64 is compressed) and the return action for the spool 62 when a pulling force is removed from the lifeline 12 (i.e., when the load 30 is moved closer to the spool 62, the rotor spring 64 returns to the neutral position and causes the spool 62 to rotate the opposite direction to retract the lifeline 12 into the housing 16). Referring to the arrangement shown in FIG. 4B, for example, an exterior pulling force applied to the lifeline 12 causes that lifeline to extend out of the center body 22 of the housing 16, the spool 62 to rotate in a counter-clockwise direction, and the rotor spring 64 to compress because the interior end 80 of the rotor spring 64 is connected to the spool 62 by the pin 83. When the exterior pulling force is removed from the lifeline 12, the compressed rotor spring 64 causes the spool 62 to rotate in a clockwise direction and the lifeline 12 to retract back into the center body 22 of the housing 16 as it is wound around the spool 62. Each of the self-retracting lanyards 46 in the fall protection system 10 perform these functions independently from one another. In other aspects of this disclosure, the rotor spring 64 may be configured with the interior end 80 and the exterior end 82 on the opposite side of the spool 62 so that extending the lifeline 12 out the housing 16 rotates the spool in a clockwise direction and retracting the lifeline 12 into the housing 16 rotates the spool in a counter-clockwise direction.

FIG. 4C shows a spool assembly 87 with two self-retracting lanyards 46 having two lifelines 12 positioned side-by-side. The self-retracting lanyards 46 are not attached to each other in the spool assembly 87; they are placed adjacent to each other or can be spaced apart. Therefore, each of the self-retracting lanyards 46 performs the functions described above independently from other self-retracting lanyards 46 in the fall protection system 10. Any number of self-retracting lanyards 46 may be included in the spool assembly 87 by positioning additional self-retracting lanyards 46 in a series next to each other as shown for example in FIG. 4D (showing four of the self-retracting lanyards 46) or in other configurations that permit operation of the self-retracting lanyards 46 in accordance with this disclosure.

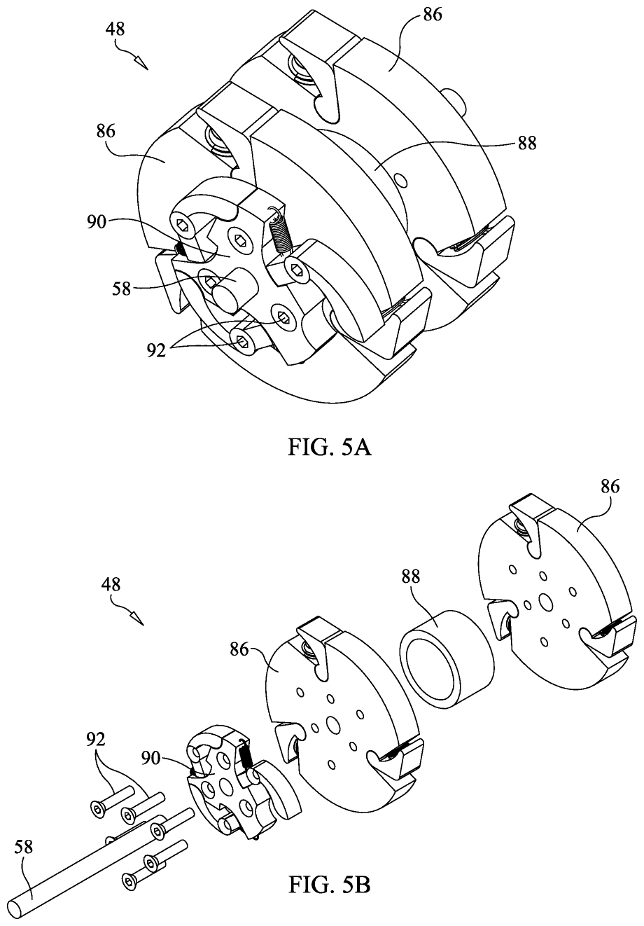

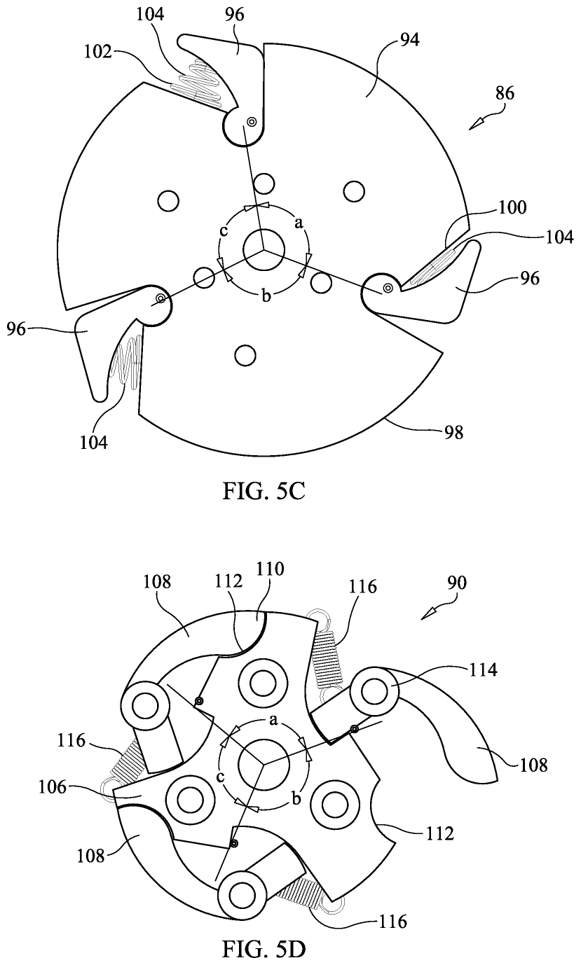

The single braking system 48 is shown in more detail in FIGS. 5A to 5D. Referring first to FIGS. 5A and 5B, the single braking system 48 includes at least two spool brake assemblies 86 connected by a torsion shaft 88 and at least one end brake assembly 90. The number of spool brake assemblies 86 will be equal to the number of self-retracting lanyards 46 that are present in the fall protection system 10. An additional torsion shaft 88 will be employed to join each additional one of the spool brake assemblies 86. The torsion shaft 88 is connected to the spool brake assemblies 86 by welding or other means suitable to achieve the functions disclosed herein. The end brake assembly 90 is connected to one of the spool brake assemblies 86 by fasteners 92 or any other means suitable to achieve the functions disclosed herein. All of these components of the single braking system 48 freely rotate around the central axle 58 of the fall protection system 10 within the center body 22 of the housing 16, i.e., the central axle 58 passes through the end brake assembly 90, the spool brake assemblies 86, and the torsion shaft 88 to permit them all to rotate around the central axle 58 at the same rotational speed. The central axle 58 is connected to the central point 60 of the end plates 24 of the housing 16 (see FIG. 3).

Referring to FIG. 5C, each of the spool brake assemblies 86 includes a spool brake wheel 94, at least one spool brake pawl 96, and a spool brake spring 104 associated with of spool brake pawl 96. Each spool brake pawl 96 is radially positioned around a circumference 98 of the spool brake wheel 94 to be movable between a compressed position 100 and an extended position 102. The spool brake spring 104 biases the spool brake pawl 96 to have a neutral position in the extended position 102.

If more than one spool brake pawl 96 is employed, they are radially positioned around the circumference 98 of the spool brake wheel 94 at unequal radial positions and/or unequal radial angles relative to each other, preferably no more than 30° off from equal radial angles. For example, if there are three spool brake pawls 96 with equal radial angles, the equal radial angles between the spool brake pawls 96 are all 120°; and if there are four spool brake pawls 96, the equal radial angles are all 90°. For the spool brake wheel 94 shown in FIG. 5C having three spool brake pawls 96 with unequal radial positions and/or unequal radial angles, the unequal radial angles between each of the spool brake pawls 96 are within a range of 90° to 150°, with the total of the unequal radial angles equal to 360°; and for a spool brake wheel 94 having four spool brake pawls 96 with unequal radial positions and/or unequal radial angles, the unequal radial angles between each of the spool brake pawls 96 are within a range of 60° to 120°. FIG. 5C shows an example of a spool brake wheel 94 having three spool brake pawls 96 with unequal radial angles where a first radial angle “a” is 120°, a second radial angle “b” is 133°, and a third radial angle “c” is 107°. However, many other configurations are possible, including increasing the number of spool brake pawls 96 and modifying the unequal radius angles between the spool brake pawls 96, depending on the size and form of the fall protection system 10 and the designed maximum weight and deceleration distance after a fall.

Referring to FIG. 5D, the end brake assembly 90 includes an end brake rotary mount 106, at least one end brake pawl 108, and an end brake spring 116 associated with each end brake pawl 108. The end brake pawl 108 is radially positioned around the end brake rotary mount 106 to be movable between a seated position 110 against a pawl stop 112 of the end brake rotary mount 106 and an activated position 114 where the end brake pawl 108 is moved away from the pawl stop 112. The end brake spring 116 biases the end brake pawl 108 to have a neutral position in the seated position 110.

Like the spool brake pawls 96 in FIG. 5C, if more than one end brake pawl 108 is employed, they are radially positioned around the end brake rotary mount 106 at unequal radial positions and/or unequal radial angles relative to each other, preferably no more than 30° off from equal radial angles. Thus, when there are three end brake pawls 108, the unequal radial angles between each of the end brake pawls 108 are in the range of 90° to 150°, with the total of the unequal radial angles equal to 360°. If there are four end brake pawls 108, the unequal radial angles between each of the end brake pawls 108 are in the range of 60° to 120°, with the total of the unequal radial angles equal to 360°. FIG. 5D shows an end brake rotary mount 106 having three end brake pawls 108 with unequal radial positions and/or unequal radius angles including a first radial angle “a” equal to 120°, a second radial angle “b” equal to 133°, and a third radial angle “c” equal to 107°. However, many other configurations are possible, including increasing the number of end brake pawls 108 and modifying the unequal radial angles between the end brake pawls 108, depending on the size and form of the fall protection system 10 and the designed maximum weight and deceleration distance after a fall.

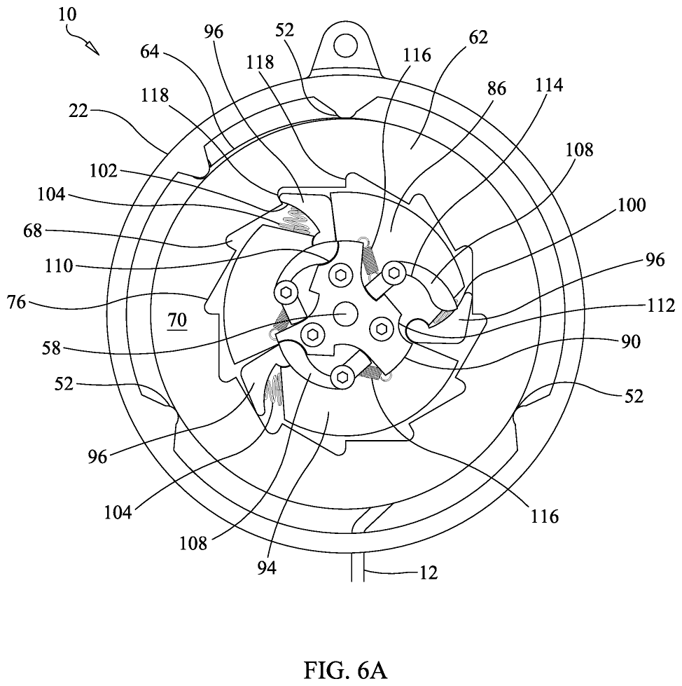

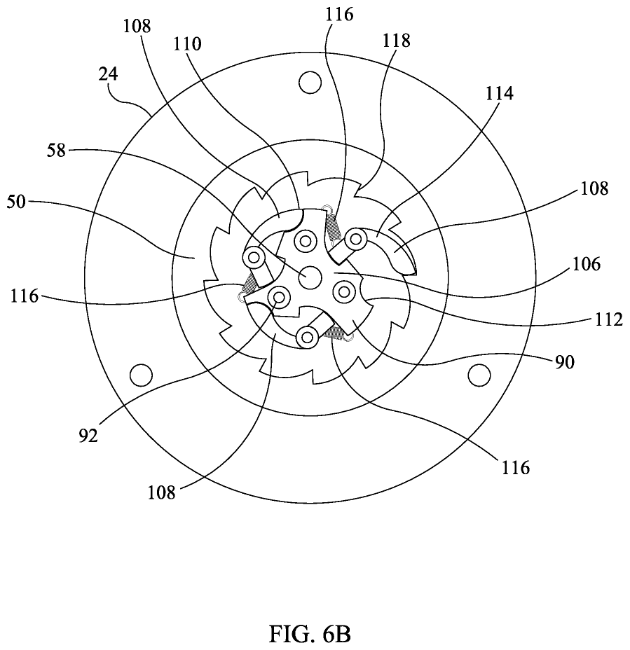

FIGS. 6A and 6B illustrate how elements of the single braking system 48 react with elements of the self-retracting lanyards 46. FIG. 6A illustrates a side view of the fall protection system 10 with the end plates 24 of the housing 16 removed to show the positioning of the spool 62 of one of the self-retracting lanyards 46, one of the spool brake assemblies 86, and the end brake assembly 90. FIG. 6B illustrates a side view of the inner surface of one of the end plates 24 that has the end brake gear 50 attached thereto. Additional self-retracting lanyards 46 positioned behind the one shown in FIG. 6A will have another of the spool brake assemblies 86 positioned like shown in FIG. 6A but the end brake assembly 90 is attached only to the spool brake assembly closest to the end plate 24 with the end brake gear 50. An additional end brake gear 50 may be used on the end plate 24 on the other side of the housing 16 if for example, in certain applications, it is desired to reduce reaction of time of the single braking system 48, or if stress on the torsion shaft 88, the end brake gear 50, or the one or more end brake pawl 108 is too high when using one end brake gear 50, or if the number or size of the self-retracting lanyards 46 is much greater, or if the fall protection system 10 is required to protect heavier weights.

Referring to FIG. 6A, the spool brake assemblies 86 are positioned in the recessed space 68 in the side surface 70 of the spool 62 of a respective one of the at least two self-retracting lanyards 46 to rotate around the central axle 58 and react directly with the spool gear 76 that surrounds the recessed space 68. FIG. 6A shows a first arrangement of one of the spool brake assemblies 86 and the spool 62 of one of the at least two self-retracting lanyards 46, with the end brake assembly 90. Positioned in series behind the first arrangement shown in FIG. 6A is a second one of the at least two self-retracting lanyards 46 with a respective second one of the spool brake assemblies 86 positioned in the spool 62 of the second one of the at least two self-retracting lanyards 46 to rotate around the central axle 58.

As previously described, all the spool brake assemblies 86 are joined together by the torsion shaft 88, which extends through and rotates freely within the central hole 72 in the spool 62 and around the central axle 58. Therefore, all the spool brake assemblies 86 rotate together at equal speeds around the central axle 58. The spool brake assemblies 86 have no power to rotate on their own or to cause rotation of the spool 62 with which it interacts. Instead, the spool brake assemblies 86 are rotated only when the force on one of the lifelines 12 causes that lifeline to extend from the housing 16 and the at least one spool 62 associated with that lifeline to rotate.

In the example shown in FIG. 6A, the spool brake springs 104 in the spool brake assemblies 86 act on the spool brake pawls 96 so that the neutral position of the spool brake pawls 96 is in the extended position 102. When a pulling force is applied to the lifeline 12 causing the lifeline 12 to extend out of the center body 22 of the housing 16, the lifeline 12 rotates the spool 62 in a clockwise direction and the rotor spring 64 on the opposite side of the spool 62 compresses. As the spool 62 rotates in the clockwise direction, the teeth 118 in the spool gear 76 interact with the spool brake pawls 96 in the extended position 102, which transfers the clockwise rotation of the spool 62 to the spool brake wheel 94.

If the spool 62 in a second one of the self-retracting lanyards 46 is rotating faster than the spool 62 shown in FIG. 6A, the teeth 118 in the spool gear 76 of the spool 62 in the second one of the self-retracting lanyards 46 will interact with the spool brake pawls 96 in the extended position 102 of a second spool brake assembly associated with the spool 62 in the second one of the self-retracting lanyards 46, which transfers the rotation of that spool 62 to the spool brake wheel 94 of the second spool brake assembly, which also transfers the clockwise rotation to all of the spool brake assemblies 86 and the end brake assembly 90 through the torsion shaft 88. Due to the interaction of the spool brake assemblies 86 with the spool gear 76 on their respective spools, the spool brake springs 104 on the spool brake assembly associated with the spool 62 that is moving at a slower rotational speed will be compressed by the spool gear 76 as the spool brake assemblies 86 rotate in a clockwise direction. The spool brake assembly associated with the spool 62 that is moving at a slower rotational speed has no power to rotate that spool 62.

Because the spool brake assemblies 86 are connected together through the torsion shaft 88 and the end brake assembly 90 is fastened to one of the spool brake assemblies 86, the spool brake assemblies 86 and the end brake assembly 90 all rotate together at a rotational speed equal to the rotational speed of the spool 62 in the self-retracting lanyards 46 that is rotating the fastest. That is, the spool brake assemblies 86 and the end brake assembly 90 rotate at the same rotational speed as the spool 62 for a lifeline 12 in one of the self-retracting lanyards 46 that is being extended out of the housing 16 the fastest relative to the speed of lifelines in other self-retracting lanyards 46 in the fall protection system 10. Further, the spool brake assemblies 86 are rotated by the fastest moving spool 62 and each spool 62 remains independent of any other spool 62 in the fall protection system 10.

When the pulling force is removed from the lifeline 12, for example when motion of the load 30 away from one of the self-retracting lanyards 46 stops, the rotor spring 64 expands and returns to its neutral position, causing spool 62 to rotate in a counter-clockwise direction and the lifeline 12 to be wound upon the spool 62. As this occurs, spool gear 76 also rotates in the counter-clockwise direction and reacts with the spool brake pawls 96 to compress the spool brake springs 104 so that the spool brake pawls 96 move out of the motion of the spool gear 76 and do not interfere with the counter-clockwise rotation of the spool 62. This allows the spool 62 to move in the counter-clockwise direction without rotating the spool brake assemblies 86. Thus, each of the self-retracting lanyards 46 operates independently from each other in extending and retracting the lifeline 12 when the load 30 is maintained in the elevated position 32.

FIG. 6B illustrates an example of an end brake gear 50 and its interaction with the end brake assembly 90 that is fastened to the first of the spool brake assemblies 86 in the series of spool brake assemblies 86. The end brake gear 50 is directly connected, by welding or other means, to an interior surface of one of the end plates 24 of the housing 16 to prevent rotation of the end brake gear 50. The end brake gear 50 provides a support for simultaneously arresting rotation of the end brake assembly 90, the spool brake assemblies 86, and the spool 62 in each of the self-retracting lanyards 46 when a fall occurs. An additional end brake assembly 90 may be used in the fall protection system 10 for example when several more of the self-retracting lanyards 46 are used or if additional arresting force is desired for a particular application. A second end brake gear would then be attached to the other of the two end plates 24 and the spool brake assembly closest to the other of the two end plates 24 can be configured with its spool gear 76 facing the other of the two end plates 24.

As previously described, the end brake springs 116 cause the end brake pawls 108 to sit in their seated position 110 resting on the pawl stop 112 of the end brake assembly 90. When the spool brake assemblies 86 rotate clockwise (i.e., when a lifeline 12 is being extended out of the housing 16), the clockwise rotation is transferred to the end brake assembly 90 because it is directly connected to one of the spool brake assemblies 86 and a centrifugal force begins to act on the end brake pawls 108 to overcome the reaction of the end brake springs 116 and move the end brake pawls 108 away from the pawl stop 112. The faster the end brake assembly 90 rotates, the further the end brake pawls 108 will extend away from the pawl stop 112.

When the end brake assembly 90 reaches a rotational speed equal to a designed threshold brake speed, mechanically sensing when a speed of any one of the self-retracting lanyards 46 has increased to the threshold brake speed (and indicating a fall), the end brake pawls 108 will extend further to the activated position 114 where the end brake pawls 108 interact with teeth 118 of the end brake gear 50. The end brake assembly 90 rotates with the spool brake assemblies 86 at a rotational speed of the fastest spool 62 until it reaches the threshold brake speed when the end brake pawls 108 interact with the end brake gear 50 to simultaneously arrest rotation of the end brake assembly 90, the spool brake assemblies 86, and the spool 62 in each of the self-retracting lanyards 46, thus arresting motion of all lifelines 12. For illustration purposes, FIG. 6B shows the end brake pawls 108 in both the seated position 110 and the activated position 114. In use, all the end brake pawls 108 will move from the seated position 110 to the activated position 114 at the same time due to the centrifugal force when end brake assembly 90 rotates. The end brake pawls 108 are configured at unequal radial positions and/or unequal radial angles relative to each other as previously described to reduce the distance the end brake assembly 90 rotates before one of the end brake pawls 108 engages with the end brake gear 50.

There are many considerations in the design of the fall protection system 10 that would affect the threshold brake speed at which the single braking system 48 engages to arrest movement of the self-retracting lanyards 46. For example, the centrifugal force that counteracts the end brake spring 116 associated with an end brake pawl 108 is affected by the mass, size, and speed of the end brake pawl 108, the position of the end brake pawl 108 from a center axis of the end brake rotary mount 106, and the distance the end brake pawl 108 has to travel before it contacts the end brake gear 50. The end brake spring 116 should be selected to counteract the centrifugal force, for example, by selecting an end brake spring 116 to have a constant (k) value and physical properties (size, material, wire diameter, total diameter) to achieve the desired result. In addition, when a diameter of the spool 62 in the self-retracting lanyards 46 is larger, the slower the fall protection system 10 will spin the end brake assembly 90. These design considerations are application dependent, for example when minimizing or eliminating fall distance and impact force for different load types and weights, and may be constrained by a federal standard, such as the Occupational Safety and Health Administration (“OSHA”). It will be appreciated that these design considerations might be complex and time-consuming but would nevertheless be a routine undertaking for those of ordinary skill in the art.

Referring to both FIGS. 6A and 6B, together with FIGS. 2 and 3, when a load 30 falls from an elevated position 32, for example off an elevated platform 34, the single braking system 48 will be engaged to simultaneously arrest movement of all lifelines 12 out of the housing 16 of the fall protection system 10 when the single braking system 48 mechanically senses that any one of the lifelines 12 reaches a designed threshold brake speed (i.e., that indicates the load 30 is falling). First, as configured in these drawings, clockwise rotation of the end brake assembly 90 is arrested when the speed of the clockwise rotation reaches the threshold brake speed by the end brake pawls 108 interacting with the end brake gear 50, which is secured to one of the end plates 24 of the housing 16. Thus, the housing 16 provides a support for the arresting motion. Because the end brake assembly 90 is directly connected to a first of the spool brake assemblies 86, clockwise rotation of the first spool brake assembly is arrested. The first spool brake assembly is directly connected to all of the spool brake assemblies 86 in the series through the torsion shaft 88. Therefore, clockwise rotation of all the spool brake assemblies 86 is arrested at the same time. With the spool brake assemblies 86 stopped, the spool brake pawls 96 on the spool brake assemblies 86 in the extended position 102 interact with the spool gear 76 on the respective spools to simultaneously arrest clockwise rotation of the spool 62 in each of the self-retracting lanyards 46 after a short distance until one of the spool brake pawls 96 interacts with the spool gear 76. With rotation of all of the spools arrested, the lifelines 12 cannot be extended any further from the housing 16. That is, movement of all the self-retracting lanyards 46 in the fall protection system 10 is arrested. Therefore, the fall of the load 30 is arrested at each point on the load 30 that is connected to a lifeline 12.

Referring again to FIG. 2, where the load 30 is a worker walking around an elevated platform 34, the fall protection system 10 is connected to the rigid support structure 42 above the worker, and the worker is connected to two lifelines 12 of self-retracting lanyards 46 in the fall protection system 10, one on the left side and one on the right side of the worker. When the worker walks to the right, the lifeline on the left will be extended and the lifeline on the right will be retracted. More particularly, the lifeline on the left rotates the spool 62 associated with that lifeline in a clockwise direction as it extends from the housing 16. The spool 62 associated with the lifeline on the left reacts with the spool brake pawls 96 of the spool brake assembly associated with the spool 62 and rotates the spool brake assembly in a clockwise direction at the same rotational speed of the spool 62. The spool brake assembly reacts with all of the spool brake assemblies 86 in the series and rotates them in a clockwise direction at the same speed.

At the same time, the spool 62 associated with the lifeline on the right rotates in a counter-clockwise direction due to the rotor spring 64 returning to its neutral position and causes the lifeline on the right to retract into the housing 16. The spool brake assembly associated with the spool 62 and lifeline on the right continues to rotate in a clockwise direction at the same speed as the spool brake assembly associated with the lifeline on the left due to the direct connection of all the spool brake assemblies 86 through the torsion shaft 88. The spool brake springs 104 in the spool brake assembly 86 associated with the lifeline 12 on the right compress as the spool brake pawls 96 react with the spool gear 76, allowing independent motion of the spool 62 associated with the lifeline on the right and the spool 62 associated with the lifeline on the left. In this scenario, the end brake assembly 90 rotates in a clockwise direction at the same rotational speed as the spool brake assemblies 86. The end brake pawls 108 extend from the pawl stop 112 due to centrifugal force, but not enough to interact with the end brake gear 50 because the rotational speed of the end brake assembly 90 has not reached the threshold brake speed.

In a scenario like the one just described, but where the load 30 falls from the elevated position 32 nearest to the pulley anchor point 41 on the left side of the rigid support structure 42, the end brake assembly 90 will engage the end brake gear 50 and arrest movement of both lifelines 12 at the same time. In this scenario, the lifeline on the left rapidly rotates the spool 62 associated with that lifeline in a clockwise direction as that lifeline rapidly extends from the housing 16. The spool 62 reacts with the spool brake pawls 96 of the spool brake assembly 86 associated with the spool 62 and rotates the spool brake assembly 86 in a clockwise direction at the same rotational speed of the spool 62. The spool brake assembly 86 reacts with all of the spool brake assemblies 86 in the series and rotates them in a clockwise direction at the same speed.

In this scenario, the lifeline on the right also rotates the spool 62 associated with that lifeline in a clockwise direction because that lifeline will also be extended from the housing 16, but at a slower speed. The spool brake assembly 86 associated with the spool 62 and the lifeline on the right rotates in a clockwise direction at the same faster speed as the spool brake assembly associated with the lifeline on the left due to the direct connection of all the spool brake assemblies 86 through the torsion shaft 88. The spool brake springs 104 in the spool brake assembly 86 associated with the lifeline on the right compress as the spool brake pawls 96 react with the spool gear 76, allowing independent motion of the spool 62 associated with the lifeline on the right and the spool 62 associated with the lifeline on the left.

The end brake assembly 90 rotates in a clockwise direction at the same rotational speed as the spool brake assemblies 86 (i.e., the rotational speed of the fastest moving spool 62, in this scenario, the spool 62 associated with the lifeline on the left). The end brake pawls 108 extend from the pawl stop 112 in the end brake assembly 90 due to centrifugal force. When the end brake assembly 90 reaches the threshold brake speed, mechanically sensing a fall, at least one of the end brake pawls 108 will interact with the end brake gear 50 and therefore stop further rotation of the end brake assembly 90. Due to the direct connection with the spool brake assemblies 86, the end brake assembly 90 stops the spool brake assemblies 86 from rotating. Because the load 30 is falling, the lifelines 12 on the right side and the left side will each continue to apply a pulling or clockwise rotational force to their respective spools, but the spool gear 76 in each spool 62 reacts with one or more of the spool brake pawls 96 in their respective spool brake assemblies 86, which prevents rotation of the spool 62 in each of the self-retracting lanyards 46 and further extension of the lifelines 12. The vertical distance from when the fall begins to when the fall is arrested is limited by the radial angles between the end brake pawls 108 and radial angles between the spool brake pawls 96. The load 30 cannot move in a horizontal direction because all the lifelines 12 stop moving at the same time. Therefore, swing hazards are eliminated.

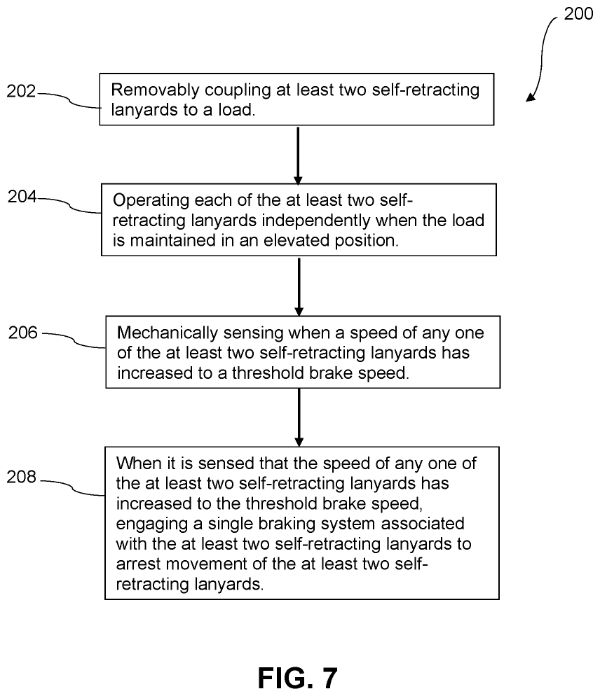

FIG. 7 shows a method 200 for protecting a load 30 when falling from an elevated position 32. In method step 202, at least two self-retracting lanyards 46 are removably coupled to the load 30 (as shown in FIG. 2). In method step 204, the two self-retracting lanyards 46 are operated independently when the load 30 is maintained in the elevated position 32. In method step 206, the method mechanically senses when a speed of any one of the at least two self-retracting lanyards 46 has increased to a threshold brake speed, and in method step 208, when it is sensed that the speed of any one of the at least two self-retracting lanyards 46 has increased to the threshold brake speed, engaging a single braking system 48 associated with the at least two self-retracting lanyards 46 to arrest movement of the at least two self-retracting lanyards 46.

The method 200 also includes configuring the at least two self-retracting lanyards with respective lifelines wound on respective spools that are configured to rotate around a central axle and torsion shaft independently of each other. That is, each of the at least two self-retracting lanyards has a spool with a lifeline wound upon it. In the method step 208, engaging the single braking system comprises engaging an end brake gear to simultaneously arrest movement of the respective spools when mechanically sensing that a rotational speed of a first spool associated with one of the two self-retracting lanyards or a spool associated with a second of the two-self-retracting lanyards has increased to the threshold brake speed, and more particularly, engaging, by the at least one pawl, the end brake gear to arrest movement of the single braking system and the respective spools, and therefore all of the lifelines in the self-retracting lanyards. In the method step 206, mechanically sensing comprises deploying at least one pawl that is movable by centrifugal force acting against a spring force to engage a spool gear when a rotational speed of a first spool of the respective spools or a second spool of the respective spools has increased to the threshold brake speed. The method 200 also includes configuring the single braking system to rotate at a rotational speed that is equal to a fastest rotational speed of a fastest one of the respective spools and configuring a spool brake assembly having at least one pawl acting against a spring force where a neutral position of the spring force is in an extended position to react with a recessed spool gear in at least one of the respective spools. The method 200 is applicable where the load is a worker, a cable-suspended platform, or a cable-suspended scaffolding.

In another method of making a fall protection system, the method includes the steps of positioning at least two self-retracting lanyards in a housing of the fall protection system and associating the at least two self-retracting lanyards with a single braking system that arrests movement of the at least two self-retracting lanyards if a speed of any one of the at least two self-retracting lanyards increases to a threshold brake speed.

Many modifications of the systems and methods disclosed herein may occur to those skilled in the art upon reading the specification including, for example, modifying the form or size of the fall protection system, or modifying the specific structure of the braking system and the gears therein. The present application includes such modifications and is limited only by the scope of the claims. The method claims set forth hereinafter should not be construed to require that the steps recited therein be performed in alphabetical order (any alphabetical ordering in the claims is used solely for the purpose of referencing previously recited steps) or in the order in which they are recited unless the claim language explicitly specifies or states conditions indicating a particular order in which some or all of those steps are performed. Nor should the method claims be construed to exclude any portions of two or more steps being performed concurrently or alternatingly unless the claim language explicitly states a condition that precludes such an interpretation.

1. A fall protection system for a load in an elevated position, the fall protection system comprising at least two self-retracting lanyards configured to be removably coupled to the load, the at least two self-retracting lanyards associated with a single braking system that arrests movement of the at least two self-retracting lanyards when the single braking system mechanically senses a speed of any one of the at least two self-retracting lanyards has increased to a threshold brake speed.

2. The fall protection system of claim 1, wherein the at least two self-retracting lanyards comprise respective lifelines wound on respective spools, and the respective spools are independently rotatable around a central axle of the fall protection system.

3. The fall protection system of claim 2, wherein the single braking system is operable to arrest movement of the respective spools when the single braking system mechanically senses that a rotational speed of any one of the respective spools has increased to the threshold brake speed.

4. The fall protection system of claim 2, wherein the single braking system comprises at least two brake assemblies respectively associated with the respective spools, and the at least two brake assemblies are rotatable around the central axle of the fall protection system at a rotational speed equal to a fastest rotational speed of one of the respective spools that is rotating faster than any other of the respective spools.

5. The fall protection system of claim 4, wherein the single braking system comprises at least one pawl that is movable by centrifugal force acting against a spring force and positioned to engage an end brake gear to arrest movement of the at least two brake assemblies and the respective spools when at least one of the respective spools has reached the threshold brake speed.

6. The fall protection system of claim 5, wherein the at least one pawl comprises at least two pawls that are radially positioned around the central axle at unequal radial angles.

7. The fall protection system of claim 2, wherein the respective spools have a recessed space in a side thereof having an outer edge that forms a gear that is operably engaged by the single braking system.

8. The fall protection system of claim 1, wherein the load is a worker, a cable-suspended platform, or a cable-suspended scaffolding.

9. The fall protection system of claim 1, wherein the fall protection system has a central axle, the at least two self-retracting lanyards comprise respective lifelines would on respective spools that are rotatable around the central axle, and the single braking system comprises:
a torsion shaft rotatable around the central axle;
a first spool brake assembly associated with a first spool of the respective spools, the first spool brake assembly rotatable around the central axle and connected to a first end of the torsion shaft; and
a second spool brake assembly associated with a second spool of the respective spools, the second spool brake assembly rotatable around the central axle and connected to a second end of the torsion shaft, such that the torsion shaft, the first spool brake assembly, and the second spool brake assembly rotate around the central axle at equal speeds.

10. A braking system for simultaneously arresting movement of at least two self-retracting lanyards, the braking system comprising:
a first spool brake assembly rotatable around a central axle and positioned to react with a first gear of a first spool of a first of the at least two self-retracting lanyards;
a second spool brake assembly rotatable around the central axle and positioned to react with a second gear of a second spool of the at least two self-retracting lanyards, the second spool brake assembly connected to the first spool brake assembly through a torsion shaft, the torsion shaft rotatable around the central axle; and
an end brake assembly rotatable around the central axle and coupled to the first spool brake assembly, such that the first spool brake assembly, the second spool brake assembly, and the end brake assembly rotate around the central axle at equal speeds.

11. The braking system of claim 10, further comprising at least one pawl that is movable by centrifugal force acting against a spring force to engage an end brake gear to arrest movement of the end brake assembly, the first spool brake assembly, the second spool brake assembly, the first spool, and the second spool when a first rotational speed of the first spool or a second rotational speed of the second spool has increased to a threshold brake speed.

12. The braking system of claim 11, wherein the at least one pawl comprises at least two pawls that are radially positioned around the central axle at unequal radial angles.

13. A method for protecting a load when falling from an elevated position, the load having at least two self-retracting lanyards removably coupled thereto, the method comprising the steps of:
operating the at least two self-retracting lanyards independently when the load is maintained in the elevated position;
mechanically sensing when a speed of any one of the at least two self-retracting lanyards has increased to a threshold brake speed; and
when it is sensed that the speed of any one of the at least two self-retracting lanyards has increased to the threshold brake speed, engaging a single braking system associated with the at least two self-retracting lanyards to arrest movement of the at least two self-retracting lanyards.

14. The method of claim 13, wherein the two self-retracting lanyards are configured with respective lifelines wound on respective spools that are configured to rotate independently of each other.

15. The method of claim 14, wherein engaging the single braking system comprises engaging a gear to arrest movement of the respective spools when mechanically sensing that a rotational speed of a first of the respective spools associated with one of the at least two self-retracting lanyards or a second of the respective spools associated with another of the at least two-self-retracting lanyards has increased to the threshold brake speed.

16. The method of claim 14, wherein mechanically sensing comprises deploying at least one pawl that is movable by centrifugal force acting against a spring force to engage a gear when a rotational speed of a first of the respective spools or a second of the respective spools has increased to the threshold brake speed.

17. The method of claim 16, wherein engaging the single braking system comprises engaging, by the at least one pawl, a brake gear of a brake assembly to arrest movement of the single braking system and the respective spools.

18. The method of claim 14, further comprising configuring the single braking system to rotate at a rotational speed that is equal to a fastest rotational speed of a fastest one of the respective spools.

19. The method of claim 14, wherein operating the two self-retracting lanyards independently comprises configuring a spool brake assembly having at least one pawl acting against a spring force where a neutral position of the spring force is in an extended position to react with a gear in at least one of the respective spools.

20. The method of claim 13, wherein the load is a worker, a cable-suspended platform, or a cable-suspended scaffolding.
